(19) United States
(12) Patent Application Publication
(10) Pub. No.: US 2010/0133773 A1
(43) Pub. Date: Jun. 3, 2010

(54) Axle Support

(76) Inventors: Thomas Buschjohann, Nordstemmen (DE); Heiko Kauert, Ludwigsfelde (DE)

Correspondence Address: COLLARD & ROE, P.C., 1077 NORTHERN BOULEVARD, ROSLYN, NY, 11576, US

(21) Appl. No.: 11/990,311

(22) PCT Filed: Sep. 8, 2006
(86) PCT No.: PCT/DE2006/001575

§ 371 Date: Feb. 11, 2008

(30) Foreign Application Priority Data
Sep. 9, 2005 (DE) 10 2005 042 985.8

(51) Int. Cl. B62D 21/11

(52) U.S. Cl. 280/124.109

(57) ABSTRACT

The invention relates to an axle support for motor vehicles. The axle support, especially a rear axle support for motor vehicles with non-powered rear axle, is constituted of two cast light-alloy longitudinal girders (A, B) which can be connected to each other by upper and lower connecting elements (C, D).

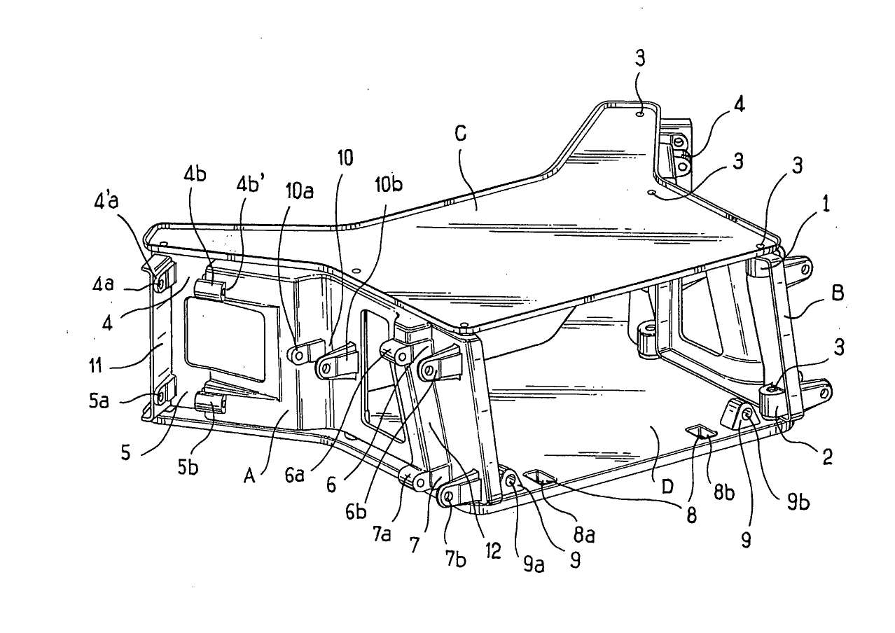

The invention relates to an axle support, also called bogie or auxiliary frame, more preferably for rear axles of motor vehicles with non-powered rear axles.

Such axle supports generally consist of two longitudinal links and two transverse links, of hollow profiles, which are connected among themselves, more preferably welded together. The axle supports comprise fastening points, holders, articulation points or the like for fastening axle or other elements and for fastening the axle support itself to body regions as prefabricated unit including the axle or other elements. These fastening points have to be prefabricated and separately fastened to the axle support themselves, which as a rule is performed through welding. Axle supports of this type are therefore involved and expensive and their use is restricted to a type of vehicle for which they were designed.

The present invention was based on the object of rendering axle supports more economical and expanding the area of application at least of individual components for multiple applications, so that merely through changing the other components, different vehicle types are to be supplied with identical individual components in order to achieve further reductions due to the higher quantities.

According to the invention this is achieved in that the axle support as assembly consists of two longitudinal girders of cast light metal which can be connected among themselves through upper and lower connecting elements. For this reason it is practical if the longitudinal girders consist of a light metal alloy and at least one of the connecting elements is a shaped sheet metal part. Such shaped sheet metal parts can be shaped sheet metal parts that are two-dimensional, also interrupted, stiffened shaped sheet metal parts or formed through individual profiled cross members or struts. In a particularly simple and economical manner the longitudinal girders can be fastened to each other with transverse connecting elements, for example shaped sheet metal parts, profiled cross members or struts through connecting elements such as screws or rivets, wherein the fastening points, i.e. for example bores or threads, can be provided particularly simply and economically in cast light metal, for example in mouldings, nodes, eyes, straps or the like specifically provided in the casting. In a practical manner the girders for example can comprise such articulation points for fastening said girders or the axle support, if applicable, including axle or other elements mounted thereon, to body parts.

It is furthermore advantageous if at least one of the girders comprises articulation or fastening points for at least three of the axle elements mentioned in the following:
for the front upper left and/or right transverse link
for the front lower left and/or right transverse link
for the rear upper left and/or right transverse link
for the rear lower left and/or right transverse link
for the track rod(s)
for the shock absorbers
for the torsion bar suspension

Such articulation points can be manufactured in a particularly favourable manner through casting. It is furthermore advantageous if at least some of the articulation or fastening points are formed by holders that stand away from the girder body and form one part with said girder body and are provided with through holes. In addition to this, at least some of the holders can likewise be reinforced eye-like about the bores in a favourable manner. Here, at least individual holders can be formed strap-like. Reinforcement creases which at least join some of the fastening points or holders among themselves can be simply and economically formed. Practically at least some of the upper and lower fastening points or holders are joined among themselves through such reinforcement creases. Furthermore it can be practical to form at least some of the fastening points, for example those for the transverse link or the track rod(s) through two holders accommodating the element to be fastened between themselves.

It is evident that the girders themselves, as well as the holders, the articulation or fastening points for the fastening of axle and other elements, as well as such fastening points for the articulation to body regions, can be very favourably manufactured through casting. Furthermore, the invention creates the possibility of using longitudinal links for different track widths, i.e. for different vehicle types.

The invention is explained in more detail by means of the exemplary embodiment shown in the Figure:

The axle support I consists of two longitudinal girders A, B of a light metal cast alloy and an upper and lower shaped sheet metal part C, D each connecting the two girders. To fasten girders A and B as well as shaped sheet metal parts C and D several fastening points 1, 2 are cast onto the girders, in which fastening screws screwed into threaded bores are provided.

In the present exemplary embodiment the girders A, B are embodied as mirror image. For improved clarity only individual regions or fastening points are therefore shown on the one or the other girder.

On the girders A, B, articulation or fastening points 4 are additionally provided for the front upper left and right transverse links, fastening points 5 for the front lower left and right transverse links, fastening points 6 for the rear upper left and right transverse links, fastening points 7 for the rear lower left and right transverse links, fastening points 8 for the transverse stabilizer as well as fastening points 9 for the left and right shock absorber. Additional fastening points 10 are provided for the left and right track rod.

The fastening points 4 to 10 each consist of two holders 4a, 4b to 10a, 10b, having bores of which, to simplify matters, merely the bores 4a′ and 4b′ are provided with reference characters.

The holders 4a, 4b, 5a, 5b, 6a, 6b, 7a, 7b, 8a, 8b, 9a, 9b and 10a, 10b are formed strap-like and as one part with the longitudinal girders A, B, wherein the straps 4a, 5a′, 6a, 7a are connected among one another through reinforcement creases 11, 12. The holders 4a, 5a are reinforced eye-like about their bores. The holders of the fastening points 4, 5, 6, 7 and 10 are formed in such a manner that they are capable of accommodating between themselves the component to be fastened, i.e. transverse link and track rod for example.

One such light metal casting alloy according to the patent application . . . dated . . . (our reference: KSM 0204) can be suitable as such in a particularly advantageous manner for components of an axle support according to the present invention, for example for the girders, which is to be fully integrated in the present application and not limited to components of axle supports.

1. An axle support, more preferably a rear axle support for motor vehicles with non-powered rear axle as assembly of two longitudinal girders of cast light metal which can be connected among themselves through upper and lower connecting elements.

2. The axle support according to claim 1, wherein the longitudinal girders consist of a light metal alloy.

3. The axle supports according to claim 1, wherein at least one of the connecting elements is a shaped sheet metal part.

4. The axle support according to claim 1, wherein at least one of the connecting elements is embodied as cross member.

5. The axle support according to claim 1, wherein the girders and/or the connecting elements can be connected with each other through fastening elements.

6. The axle support according to claim 1, wherein the girders have articulation or fastening points for the connecting of said girders or the axle support to body parts or regions.

7. The axle support, more preferably according to claim 1, wherein at least one of the girders has articulation or fastening points for at least three of the axle elements mentioned in the following:
for the front upper left and/or right transverse link
for the front lower left and/or transverse link
for the rear upper left and/or right transverse link
for the rear lower left and/or right transverse link
for the track rod(s)
for the shock absorbers
for the torsion bar suspension

8. The axle support according to claim 7, wherein at least some of the articulation or fastening points are formed through holders which are provided with through holes, stand away from the girder body and form one part with said girder body.

9. The axle support according to claim 8, wherein at least some of the holders are embodied strap-like.

10. The axle support according to claim 7, wherein at least some of the fastening points are embodied through two holders accommodating the axle support to be fastened between themselves.

11. The axle support according to claim 8, wherein at least some of the holders are reinforced eye-like about the bores.

12. The axle support according to claim 7, wherein at least some of the fastening points or holders are connected among themselves through reinforcement creases.

13. The axle support according to claim 7, wherein at least some of the upper and lower fastening points or holders are connected among themselves through reinforcement creases.
